(19) United States
(12) Patent Application Publication
(10) Pub. No.: US 2013/0099883 A1
(43) Pub. Date: Apr. 25, 2013

(54) REACTOR

(71) Applicant: Toyoyuki Sato, Toyota-shi (JP)

(72) Inventor: Toyoyuki Sato, Toyota-shi (JP)

(73) Assignee: TOYOTA JIDOSHA KABUSHIKI KAISHA, Toyota-shi, Aichi-ken (JP)

(21) Appl. No.: 13/805,525

(22) PCT Filed: Jun. 3, 2011
(86) PCT No.: PCT/IB11/01211

§ 371 Date: Dec. 19, 2012

(30) Foreign Application Priority Data
Jun. 23, 2010 (JP) 2010-142418

(51) Int. Cl. H01F 27/08

(52) U.S. Cl. CPC H01F 27/08
USPC 336/55; 427/58

(57) ABSTRACT

A reactor is provided with: a reactor core that is generally annular and that has a coil; and one of a housing and a cooler to which the reactor core, having the coil, is fixed via an adhesive region that is formed of a moisture-curable adhesive, wherein the adhesive region is discontinuous in at least one planar direction of the adhesive region.

### BACKGROUND OF THE INVENTION

1. Field of the Invention

The invention relates to a reactor that can be provided in electric vehicles, hybrid vehicles, and the like.

2. Description of Related Art

From JP 2009-231495 A there is known a reactor including a reactor core of an almost annular shape in a plan view, bobbins encircling a part of the outer periphery of the reactor core, a coil wound around the bobbins, and a cooler glued to the reactor core with the coil wound around the bobbins. Among an area of the reactor core that is not encircled with the bobbins, at least an area closer to the cooler is housed in a resin member, whose outline get widened toward the cooler and bottom face is glued to the cooler. The coil and resin member are glued/fixed to the cooler via an adhesive having an insulating property and a high heat dissipating property.

Typically, a reactor used in a power conversion circuit is provided with a reactor core that is generally annular and wide as viewed vertically and, for example, two coils provided at the periphery of the reactor core, and is housed in a housing (case) (note that there are reactors having no such housing). More specifically, in some forms of such reactors, an insulating resin member is integrally formed at the entire circumference of the reactor core and is used also as a bobbin, or a bobbin is provided at the periphery of a portion of the reactor core. With regard to the structure of such a reactor core, it includes separate cores that are each constituted of a plurality of electromagnetic steel plates stacked on top of each other or a dust core, and a non-magnetic gap plate or a non-magnetic spacer is provided between the separate cores, and the gap plate (or the spacer) and each separate core are adhered to each other using an adhesive.

A heat radiation plate (heat sink), a cooler through which a coolant (e.g., low-temperature water, low-temperature air) is circulated, or the like, is provided at the lower face (bottom face) of the reactor core described above. The heat that is generated at the coil as the reactor is driven is transferred from the coil to the heat sink, etc. via an adhesive region or the heat of the coil is transferred to the reactor core and then transferred to the heat sink, etc. via an adhesive region, preventing the temperatures of the coil and reactor core from increasing beyond a predetermined temperature.

For example, Japanese Patent Application Publication No. 2009-231495 (JP-A-2009-231495) describes a reactor, in which a reactor core provided with a coil and a cooler are bonded to each other using an adhesive having a high heat conductivity.

Meanwhile, in some forms of reactors, a reactor core or a coil provided on the reactor core is adhered to a bottom plate of a housing using an adhesive, and a heat sink or a cooler is provided below the bottom plate of the housing.

Meanwhile, heat-curable adhesives or moisture-curable adhesives that cure by absorbing the moisture in the air at room temperatures may be used as the adhesive for adhering a reactor core or a coil to a housing or to a cooler (e.g., heat sink).

In a case where a heat-curable adhesive is used, there is a possibility that the performances of the electronic parts and components deteriorate due to the thermal loads that are imposed when they are exposed to the high-temperature atmosphere for heating and thus curing the heat-curable adhesive. Further, in this case, a large heating furnace may be required depending upon the size, capacity, and the like, of the reactor core, resulting in an increase in the cost of manufacturing equipments.

Such problems that may be caused by the use of a heat-curable adhesive, however, can be avoided by using a moisture-curable adhesive instead. In a case where a moisture-curable adhesive is used, the applied adhesive cures from the surface to the deep inside thereof, and therefore the curability of the applied adhesive is significantly low at the deep inside thereof, and thus the time required for curing the entirety of the applied adhesive is long, that is, the time required for completing the adhesive application is long, which is a great problem.

Further, this problem has become more serious because the moisture passages in an adhesive are becoming narrower and narrower With the amount of the filler added to the adhesive being increased in order to accomplish a high heat conductivity of the adhesive, which has been required to cope with the increased heat generation densities of the recent electronic parts and components.

In the meantime, with regard to the adhesive viscosity, if it is too low, the applied adhesive runs, failing to remain in a desired form, and this may result in insufficient adhesion of a reactor core and a coil, which are sources of heat generation, reducing their heat dissipation performances.

### SUMMARY OF THE INVENTION

The invention provides a reactor in which a reactor core or a coil provided on the reactor core is adhered, using a moisture-curable adhesive, to a bottom plate of a housing or to a cooler, and which is structured to promote the curing of the adhesive and achieve a manufacturing time much shorter than that for related-art reactors.

A first aspect of the invention relates to a reactor including: a reactor core that is generally annular and that has a coil; and one of a housing and a cooler to which at least one of the reactor core and the coil is fixed via an adhesive region that is formed of a moisture-curable adhesive, wherein the adhesive region is discontinuous in at least one planar direction of the adhesive region.

This reactor may be such that the adhesive region is constituted of a plurality of adhesive portions that are each formed of the moisture-curable adhesive and that are discontinuously arranged.

The reactor described above may either be provided with or without the housing for accommodating the reactor core. When the housing is to be provided, it may either be a housing having a bottom plate or a housing having no bottom plate. Further, the cooler may be selected, for example, from among a heat radiation plate (heat sink), a coolant circulator through which a coolant (e.g., low-temperature water, low-temperature air) is circulated, a set of cooling fins, and a unit constituted of any combination among them.

Further, the portion to which the reactor core having the coil is adhered using the adhesive varies depending upon the structure of the reactor, for example, such that the coil provided at the periphery of the reactor core is adhered to the housing or to the cooler or such that a portion or portions of the reactor core and the coil are adhered to the housing or to the cooler.

For example, the reactor core may be constituted of two U-shaped magnetic cores or such two U-shaped magnetic cores and I-shaped cores that are bonded to each other via gap plates, spacers, and the like, using an adhesive. Further, an insulating resin member may be integrally formed at the entire circumference of the reactor core, and a portion of the insulating resin member may be used also as a bobbin for the coil.

Further, the reactor described above may be such that the coil provided at the periphery of the reactor core and/or a portion or portions of the reactor core are connected to the bottom plate of the housing or to the cooler via the adhesive region(s) formed of the moisture-curable adhesive and the adhesive portions in the adhesive region are discontinuously arranged. Further, it is to be noted that a cold-setting adhesive may be used in place of “moisture-curable adhesive” in the invention where appropriate.

“Moisture-curable adhesive” is an adhesive that cures by being exposed to the moisture in the air and thus no heating process is required to cure it, unlike “heat-curable adhesive”. However, it is to be noted that the curing rate of a moisture-curable adhesive differs depending upon its material, the temperature, and the humidity. For example, the temperature range for curing moisture-curable adhesives is as wide as about 10 to 60° C. Thus, some moisture-curable adhesives require a certain level of heating for curing. Even in such a case, however, the required heating temperature range is not as high as that for heat-curable adhesives, which is about 80 to 200° C., and therefore no large heating equipment is needed.

In general, the use of a moisture-curable adhesive may result in an increase in the manufacturing time as mentioned earlier. According to the reactor described, however, since the adhesive region is constituted of the multiple adhesive portions that are discontinuously arranged, as compared to cases where the adhesive region is constituted of only one flat adhesive portion having a large area as in the related-art reactors, the total area of the surfaces exposed to the atmosphere in the adhesive region (i.e., the specific surface area of the applied adhesive) is large and the distance from the surface of each adhesive portion to the center thereof is short, promoting the curing of the adhesive and thus shorting the time required for curing the adhesive to the level at which the required adhesive strength is achieved. As such, an increase in the manufacturing time, which may otherwise be caused by the use of a moisture-curable adhesive as mentioned earlier, can be avoided reliably.

Adhesion via a plurality of the discontinuous adhesive portions may be executed by applying the moisture-curable adhesive onto a bottom plate of the housing using a mask that has a plurality of openings with a desired pitch, each opening having a desired planer shape, by causing the adhesive contact with the reactor core, and by curing the adhesive.

Further, in the reactor described above, the planar shapes of the adhesive portions are, for example, round, elliptic, or polygonal (e.g., square, rectangular). That is, the adhesive portions may be formed in various shapes.

Further, in the reactor described above, the moisture-curable adhesive is not particularly limited and may be, for example, a silicone-based moisture-curable adhesive or an acryl-based moisture-curable adhesive. Further, since the adhesive forms, when cured, the paths for heat transfer from the reactor core to the cooler, etc., a moisture-curable adhesive containing a heat-conductive filler containing, for example, at least one of silica, alumina, aluminum nitride, and boron nitride may be used in order to enhance the heat transfer through it.

Further, the reactor described above may be such that the adhesive portions are spaced at least 0.5 mm apart from each other. According to this structure, it is possible to prevent contacts between the adhesive portions even when one or more of them slightly deform downwardly.

Meanwhile, the reactor of the first aspect of the invention may be such that the adhesive region is constituted of an elongated adhesive portion that is formed of the moisture-curable adhesive and that extends continuously or a plurality of elongated adhesive portions that are each formed of the moisture-curable adhesive and that are discontinuously arranged.

The continuously extending elongated adhesive portion may be a single elongated adhesive portion that meanders or a single elongated adhesive portion that is spiral.

Further, the plurality of discontinuously arranged elongated adhesive portions may be straight elongated adhesive portions that are substantially in parallel to each other and are spaced apart from each other or circular elongated adhesive portions that are different in diameter from each other and are spaced apart from each other.

Further, the reactor described above may be such that the continuously extending elongated adhesive portion or the discontinuously arranged elongated adhesive portions is or are formed by applying the moisture-curable adhesive onto one of a bottom plate of the housing and the cooler while moving an application nozzle continuously. Therefore, it is possible to form the adhesive portions onto the bottom plate, or the like, by moving an application nozzle continuously. Thus the reactor improves the application efficiency than the reactor in the related art.

Further, the reactor described above may be such that the discontinuously arranged elongated adhesive portions are spaced at least 0.5 mm apart from each other. According to this structure, it is possible to prevent contacts between the adhesive portions even when one or more of them slightly run.

Further, a moisture-curable adhesive having a viscosity of at least 250 Pa·s may be used as the moisture-curable adhesive in the reactors described above.

If the adhesive viscosity is too low, the applied adhesive runs, failing to remain in a desired form, and this may result in insufficient areas of adhesions for the reactor core and coil, which are sources of heat generation, reducing their heat dissipation performances.

The inventor has discovered, through some tests, that as long as the viscosity of an adhesive is 250 Pa·s or higher, the uncured adhesive does not, after applied, run, and this achieves a desired area of adhesion for the coil, etc., providing a desired heat conductivity and thus suppressing an increase in the temperature of the reactor core. Preferably, an adhesive having a viscosity of 250 Pa·s or higher is applied onto, for example, the bottom plate of the housing, and then the reactor core is put, for adhesion, on the adhesive within 10 minutes from its application.

Further, the viscosity of the moisture-curable adhesive may be within a range of 250 to 300 Pa·s. In this case, it is possible to prevent the moisture-curable adhesive from running after applied and thus failing to remain in a desired form, while preventing a decrease in the efficiency in the adhesive application.

The reactor described above may be such that the adhesive region includes at least five gaps that are free of the moisture-curable adhesive and that are arranged in the at least one planar direction of the adhesive region.

According to the reactor of the invention, as mentioned above, the adhesive region, via which the reactor core having the coil is bonded to the housing or the cooler, is formed of the moisture-curable adhesive, and the adhesive region is made discontinuous in at least one planar direction thereof by being constituted of, for example, the multiple adhesive portions that are discontinuously arranged, the continuously extending elongated adhesive portion, or the multiple elongated adhesive portions that are discontinuously arranged. Therefore, it is possible to cure the adhesive without any heating process (i.e., no heating equipment or process is required, and therefore the manufacturing efficiency can be improved, and the manufacturing cost can be reduced), while avoiding an increase in the time required for curing the entirety of the adhesive applied. Thus, the reactor of the invention is especially suitable for the use in the recent hybrid vehicles and electric vehicles that require a high manufacturing efficiency and low manufacturing cost for each part and component to be used in them.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a vertical and longitudinal cross-sectional view of an example embodiment of a reactor according to the invention;

FIG. 2A is a cross-sectional view taken along the line indicated by the arrows II in FIG. 1;

FIG. 2B is a view, corresponding to FIG. 2A, of a related-art reactor;

FIG. 3A is a view illustrating the total area of the surfaces exposed to the atmosphere in the adhesive region of the reactor of the invention;

FIG. 3B is a view illustrating the total area of the surfaces exposed to the atmosphere in the adhesive region of the related-art reactor;

FIG. 4A is a view schematically showing an example form of the adhesive region;

FIG. 4B is a view schematically showing another example form of the adhesive region;

FIG. 4C is a view schematically showing another example form of the adhesive region;

FIG. 4D is a view schematically showing another example form of the adhesive region;

FIG. 4E is a view schematically showing another example form of the adhesive region;

FIG. 5A is a view showing a test piece that was used in a shearing test conducted for examining the relations between the time for which the adhesive region was cured and the resultant adhesive strength;

FIG. 5B is a set of cross-sectional views each taken along the line indicated by the arrows b in FIG. 5A and illustrating, respectively, the adhesive regions of a comparative example and first to fifth examples of the invention;

FIG. 6 is a graph indicating a result of the shearing test;

FIG. 7 is a graph indicating another result of the shearing test;

FIG. 8 is a graph indicating another result of the shearing test;

FIG. 9 is a graph indicating another result of the shearing test; and

FIG. 10 is a graph illustrating a result of a test for examining the relations between the respective adhesion viscosities and the resultant reactor core operation temperatures.

### DETAILED DESCRIPTION OF EMBODIMENTS

Hereinafter, example embodiments of the invention will be described with reference to the drawings. While a cooler is arranged below a housing in the example illustrated in the drawings, the cooler and a reactor core may be directly connected via an adhesive region or a sealing resin member may be provided between the housing and the reactor core.

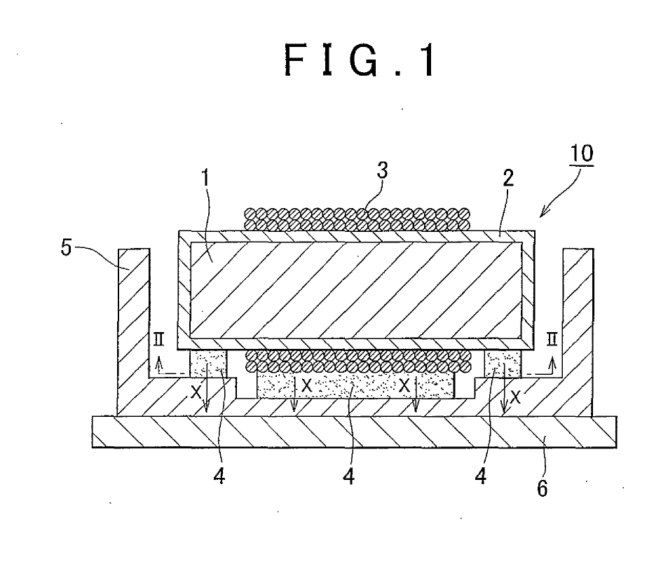

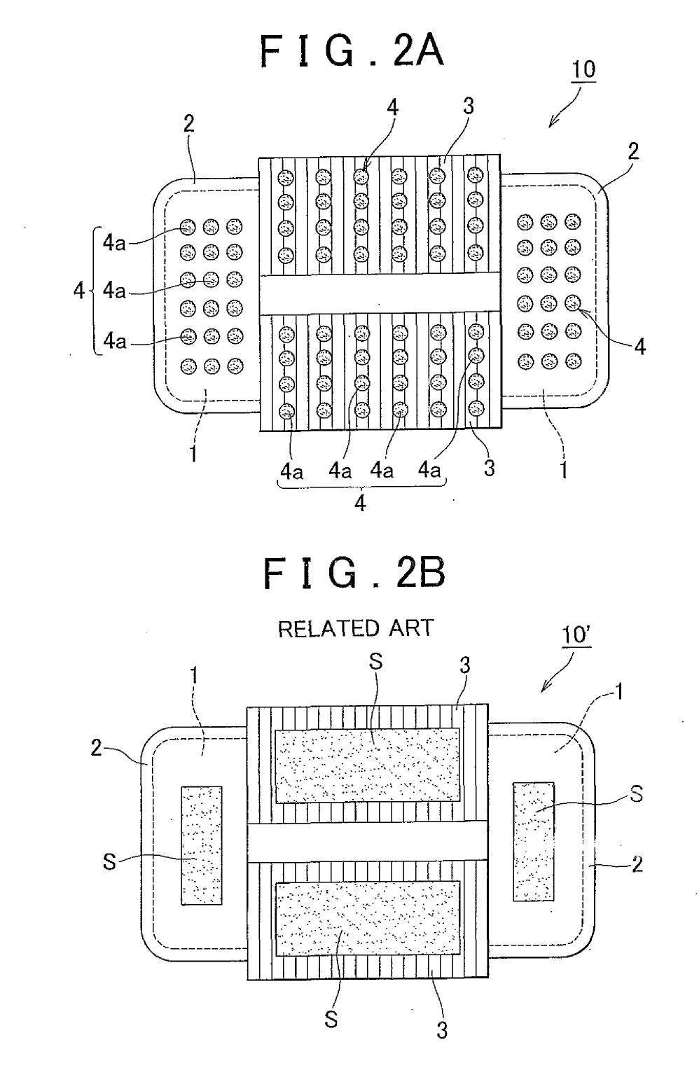

FIG. 1 is a vertical and longitudinal cross-sectional view of an example embodiment of a reactor 10 according to the invention. FIG. 2A is a cross-sectional view taken along the line indicated by the arrows II in FIG. 1. FIG. 2B is a cross-sectional view, corresponding to that in FIG. 2A, of a related-art reactor.

Referring to the drawings, with regard to the entire structure of the reactor 10, an insulating resin member 2 is integrally formed at the outer periphery of a reactor core 1 that is generally annular, and a coil 3 is provided at the periphery of a portion, serving also as a bobbin for the coil 3, of the insulating resin member 2, and the reactor core 1 and the coil 3 are adhered to the bottom plate of a housing 5 via multiple adhesive regions 4, and a cooler 6 is provided below the bottom plate of the housing 5. It is to be noted that the reactor core 1 and the housing 5, which are bonded via two of the adhesive regions 4, may be further bolted to each other (this structure is not shown in the drawings).

As a whole, the reactor core 1 is annular, having two cores that are U-shaped as viewed vertically and are adhered, at their forked sides, to each other via a gap plate (not shown in the drawings). The U-shaped cores are dust cores each formed by pressing a magnetic powder, and the gap plate is a ceramic. The magnetic powder as the material of the dust cores may be, for example, selected from among an iron powder, an iron-silicon-based alloy powder, an iron-nitrogen-based alloy powder, an iron-nickel-based alloy powder, an iron-carbon-based alloy powder, an iron-boron-based alloy powder, an iron-cobalt-based alloy powder, an iron-phosphorus-based alloy powder, an iron-nickel-cobalt-based alloy powder, and an iron-aluminum-silicon-based alloy powder. The gap plate is made of a ceramic material, such as alumina (Al₂O₃) and zirconia (ZrO₂). It is to be noted that the gap plate does not need be provided between the U-shaped reactor cores if the required or desired electromagnetic characteristic (i.e., inductance) of the reactor core can be ensured without the gap plate.

The cooler 6 may be a heat sink, a coolant circulator through which a coolant is circulated, a set of cooling fins, or any combination among them.

Each adhesive region 4 is formed of a cured moisture-curable adhesive. Referring to FIG. 1, the heat of the coil 3 and the heat of the reactor core 1 are transferred to the cooler 6 via the respective adhesive regions 4 (refer to the directions indicated by the respective arrows X shown in FIG. 1). It is to be noted that a silicone-based moisture-curable adhesive or an acryl-based moisture-curable adhesive may be used as the moisture-curable adhesive stated above. Further, it is to be noted that the moisture-curable adhesive forms, when cured, the paths for heat transfer from the reactor core 1 to the cooler 6, etc., as shown in the drawings, and therefore a moisture-curable adhesive containing a heat-conductive filler containing, for example, one or more of silica, alumina, aluminum nitride, and boron nitride may be used as the moisture-curable adhesive stated above in order to enhance the heat transfer through it

Referring to FIG. 2A, the adhesive regions 4 are each constituted of a plurality of adhesive portions 4a that are generally round and small in area as viewed vertically and that are arranged spaced apart from each other. That is, each adhesive region 4 is discontinuous, constituted of the adhesive portions 4a discontinuously arranged.

The adhesive portions 4a shown in FIG. 2A are formed by positioning a mask (not shown in the drawings), having openings corresponding to the respective adhesive portions 4a, on a predetermined portion of the housing 5, for example, then applying the moisture-curable adhesive onto the corresponding surface of the housing 5 via each opening of the mask, and then putting, for adhesion, the reactor core 1 with the coil 3 on the applied adhesive within a given period of time from the application of the adhesive.

With the multiple small area adhesive portions 4a arranged spaced apart from each other as shown in FIG. 2A, when the area of each adhesive region S of the related-art reactor 10′ is equal to or substantially equal to the total area of the adhesive portions 4a of the corresponding adhesive region 4 when viewed vertically, each adhesive region 4 is exposed to the atmosphere via an area much larger than the area via which the corresponding adhesive region S of a related-art reactor 10′ shown FIG. 2B is.

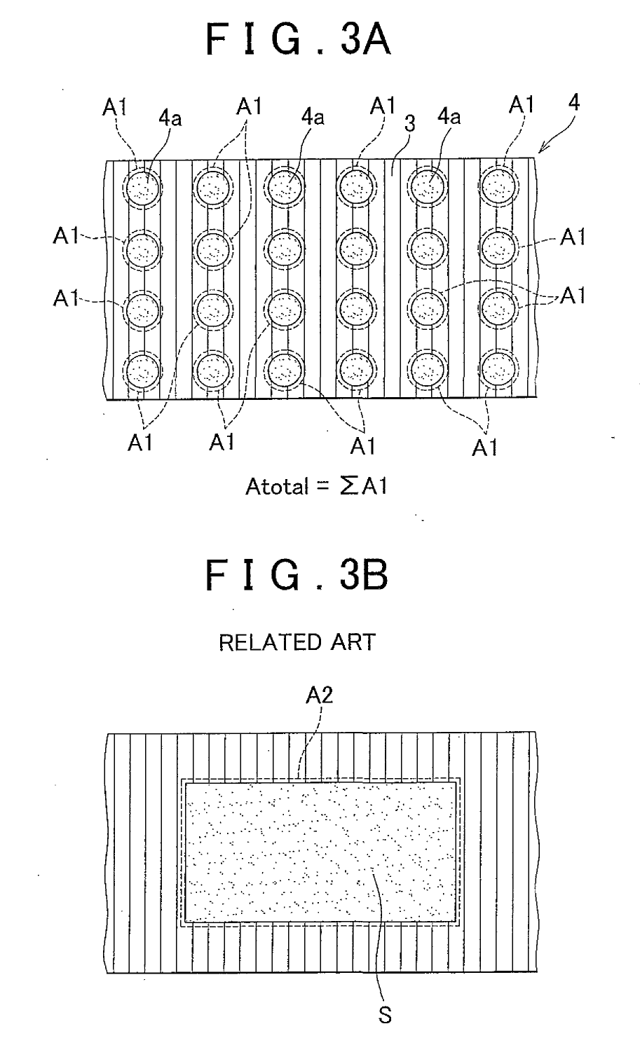

More details on this point will be described with reference to FIGS. 3A and 3B. FIG. 3A is an enlarged view of one of the adhesive regions 4 for the coil 3 of the reactor 10 of the invention, which is shown in FIG. 2A, and FIG. 3B is an enlarged view of the corresponding one of the adhesive regions S for the coil 3 of the related art reactor 10′, which is shown in FIG. 2B.

Referring to FIGS. 3A and 3B, the total planer area (i.e., the total area visually recognizable in FIG. 3A) of the adhesive portions 4a constituting the adhesive region 4 is equal to or substantially equal to the planar area of the adhesive region S. Therefore, in a case where the same adhesive is used for both the adhesive region 4 and the adhesive region S, their heat conductivities are substantially equal to each other.

The portions of the respective adhesive portions 4a of the adhesive region 4 that are exposed to the atmosphere are their side faces as indicated by the respective dotted circles in FIG. 3A. Thus, when the area of the side face of each adhesive portion is expressed as A1, the total area, Atotal, of the side faces of all the adhesive portions 4a of the adhesive region 4 is ΣA1.

On the other hand, the adhesive region 5, which is rectangular as viewed vertically, has only the four side faces as indicated by the dotted rectangle in FIG. 3B, and the total area A2 of the four side faces is significantly smaller than ΣA1. Further, the distance from the side face of each adhesive portion 4a to the center of the inside thereof is significantly shorter than the distances from the respective side faces of the adhesive region S to the center of the inside thereof.

Thus, as compared to the adhesive regions S of the related-art reactor 10′, the adhesive regions 4, which are provided to adhere the reactor core 1 (and the coil 3) of the reactor 10 of the invention to the housing 5, each have a significantly large total area of side faces exposed to the atmosphere, and further, the distance from the side face of each adhesive portion 4a of the adhesive region 4 to the center thereof is significantly short, thus promoting the curing of the adhesive and avoiding an increase in the required manufacturing time, which may otherwise be caused by the use of a moisture-curable adhesive as mentioned earlier.

A moisture-curable adhesive having a viscosity of at least 250 Pa·s may be used to form the adhesive regions 4.

The inventors have discovered, through some tests, that the use of a moisture-curable adhesive having a viscosity lower than 250 Pa·s increases the possibility that the adhesive run after its application and thus fail to remain in the required form, and it may make the areas of adhesions for the reactor core and the coil insufficient, resulting in an excessive increase in the temperature of the reactor core during its operation. Therefore, preferably, a moisture-curable adhesive having a viscosity of at least 250 Pa·s is used, and in this case, more preferably, the reactor core and the coil are put on the applied adhesive within 10 minutes from its application. It is to be noted that the adhesive portions are preferably spaced approximately 0.5 mm apart from each other in order to prevent contacts between them even when one or more of them slightly run.

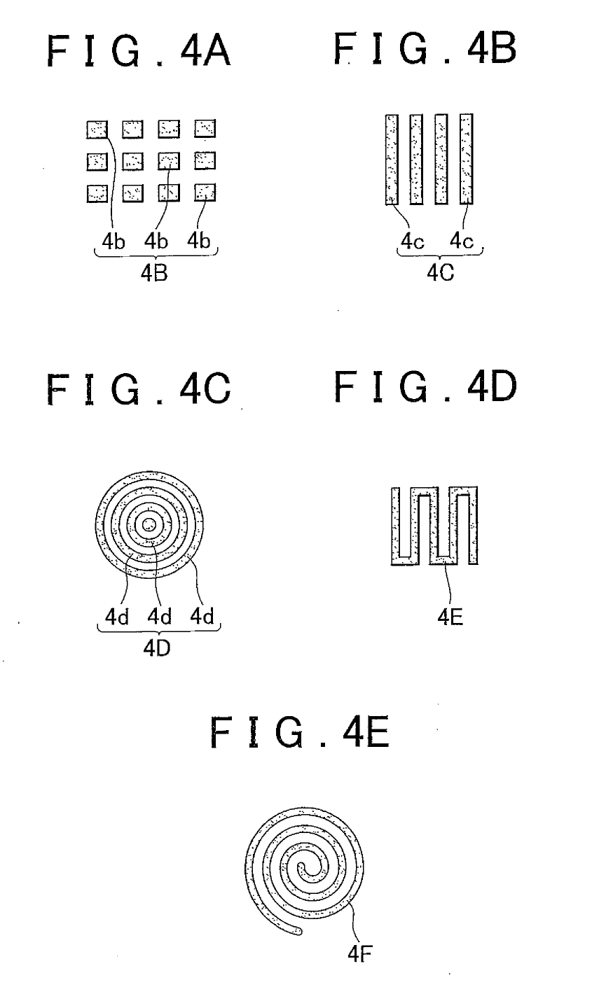

Example forms of the adhesive regions 4 are schematically shown in FIGS. 4A to 4E. An adhesive region 4B shown in FIG. 4A is constituted of a plurality of adhesive portions 4b that are rectangular as viewed vertically and are discontinuously arranged. An adhesive region 4C shown in FIG. 4B is constituted of a plurality of adhesive portions 4c that are elongated as viewed vertically and are discontinuously arranged.

An adhesive region 4D shown in FIG. 4C is constituted of a plurality of adhesive portions 4d that are elongated in circle as viewed vertically, having different diameters, and are discontinuously arranged. An adhesive region 4E shown in FIG. 4D is constituted of a single elongated adhesive portion that meanders as viewed vertically. An adhesive region 4F shown in FIG. 4E is constituted of a single elongated adhesive portion that is spiral as viewed vertically. [0053] As in the adhesive regions 4 shown in FIG. 2A, in each of the adhesive regions 4B to 4F, the distance from each side face exposed to the atmosphere to the center is shaft, and the total area of the side faces exposed to the atmosphere is significantly larger than the total area of the side faces exposed to the atmosphere in the adhesive region in the related-art reactor 10′.

In an example method for forming the elongated adhesive portions shown in FIGS. 4B to 4E, they are formed by simply moving, during the adhesive application, the application nozzle continuously, that is, they can be formed without masking, unlike the adhesive portions 4a and 4b shown in FIGS. 2A and 4A, achieving a relatively high adhesive application efficiency.

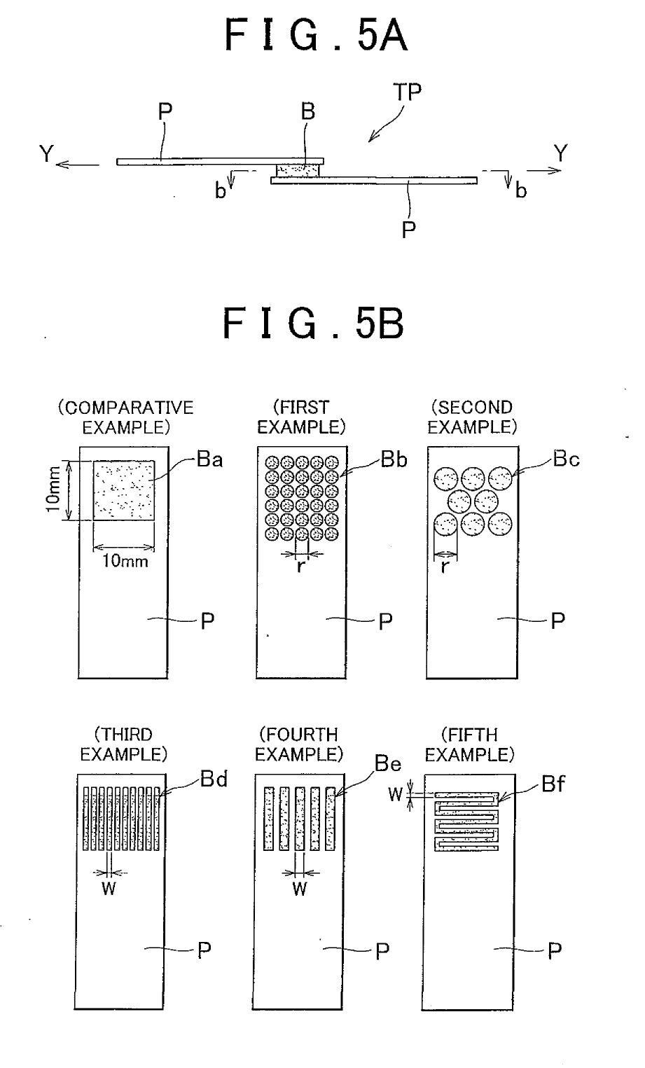

Referring to FIG. 5A, the inventors prepared test pieces TP each constituted of two members P that are made of a pure aluminum (A1050) and adhered to each other via an adhesive region B as shown in FIG. 5A. More specifically, the inventors prepared six test pieces TP each having the adhesive region B in a different form as shown in FIG. 5B. The six test pieces TP include the test piece TP of a comparative example including an adhesive region Ba, the test piece TP of a first example of the invention including an adhesive region Bb constituted of adhesive portions each of which is round having a relatively small area (diameter r), the test piece TP of a second example of the invention including an adhesive region Bc constituted of adhesive portions each of which is round having a relatively large area, the test piece TP of a third example of the invention including an adhesive region Bd constituted of adhesive portions each of which is elongated (e.g., strip-shaped) and is relatively small in width (width w), the test piece TP of a fourth example of the invention including an adhesive region Be constituted of adhesive portions each of which is elongated (e.g., strip-shaped) and is relatively large in width, and the test piece TP of a fifth example of the invention including an adhesive region Bf constituted of an elongated adhesive portion that meanders.

The total adhesion areas of the respective test pieces TP are equally set to 100 mm², and the thickness of each adhesive region B is 2 mm, and the used moisture-curable adhesive was cured at the temperature of 25° C. and the humidity of RH55%.

The adhesive of each test piece TP was cured multiple times for different periods of time, and the adhesive strength was measured each time by performing a tensile test on the test piece TP. Table 1 shown below illustrates the conditions of the adhesive region of each of the test pieces TP of the comparative example and the first to fifth examples of the invention, and the results of study on the adhesive curing times and the resultant adhesive strengths are shown in the graphs of FIGS. 6 to 9, for each of which a factor that influences the adhesive curing promotion has been picked up.

TABLE 1

| | Compara- | First | Second | Third | Fourth | Fifth |
|---|---|---|---|---|---|---|
| | tive | Exam- | Exam- | Exam- | Exam- | Exam- |
| | Example | ple | ple | ple | ple | ple |
| Size | 10 mm × | r = 1.03 | r = 2.0 | w = 1.0 | w = 2.0 | w = 2.0 |
| | 10 mm | mm | mm | mm | mm | mm |
| Number of | 1 | 30 | 8 | 10 | 5 | length = |
| adhesive | | | | | | 50 mm |
| portions | | | | | | |
| Surface area | 80 | 388 | 201 | 440 | 240 | 208 |
| (mm²) | | | | | | |

The graph of FIG. 6 illustrates the result of comparison between the comparative example, the first example, and the third example. Referring to the graph of FIG. 6, it is possible to examine, in comparison with the comparative example, the curing promotion effects of the first example having the adhesive region constituted of a plurality of round adhesive portions that are shaped like “spots” and the third example having the adhesive region constituted of a plurality of elongated adhesive portions.

Referring to the graph of FIG. 6 in which the threshold value of the adhesive strength is set to approximately 2.7 MPa, it took as long as about 48 hours for the adhesive region of the comparative example to reach the threshold value of the adhesive strength, while it took only about 8 hours for the adhesive regions of the first and third examples to reach the threshold value of the adhesive strength. Thus, it has been proved that the first and third examples can each provide a significantly better curing promotion effect.

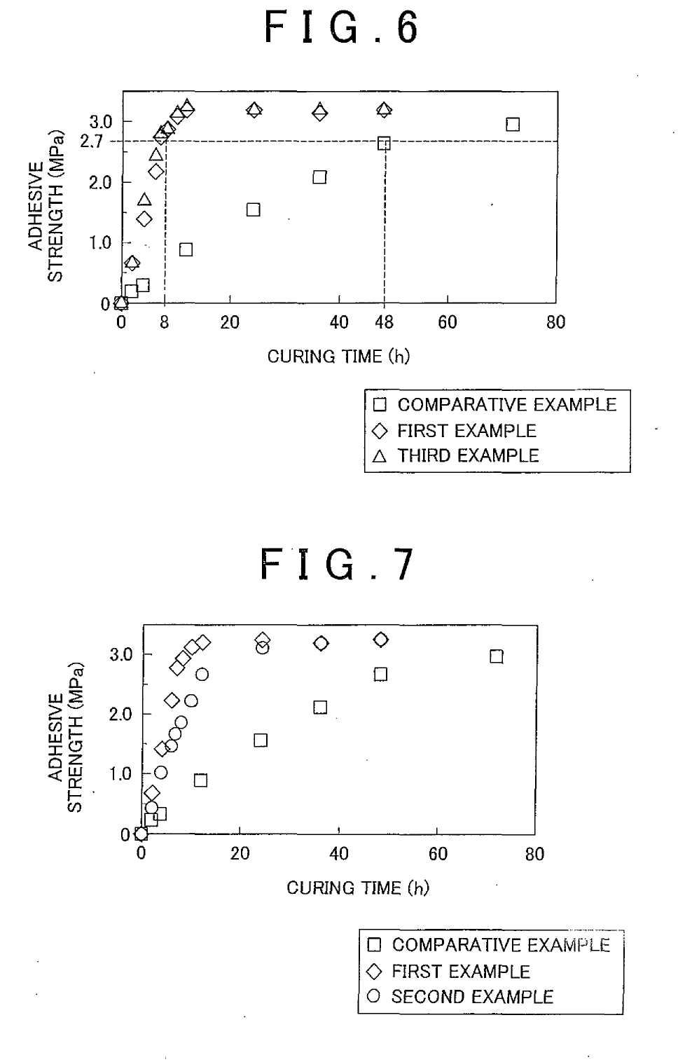

Meanwhile, the graph of FIG. 7 illustrates, in comparison with the comparative example, how the curing promotion was influenced by the difference between the diameter of each adhesive portion of the adhesive region of the first example, which is constituted of a plurality of round adhesive portions, and the diameter of each adhesive portion of the adhesive region of the second example, which is also constituted of a plurality of round adhesive portions.

Referring to the graph of FIG. 7, the total surface area of the side faces in the adhesive region of the first example, which is constituted of the smaller diameter adhesive portions, is as large as about twice the total surface area of the side faces in the adhesive region of the second example, and thus the curing promotion effect of the first example is better than that of the second example.

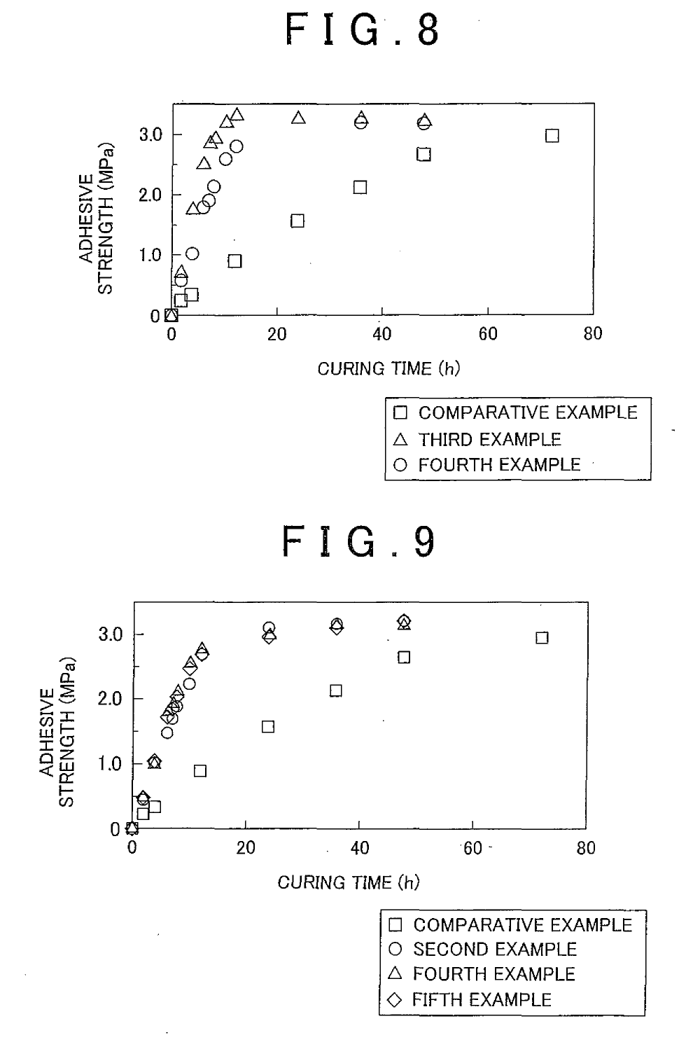

Meanwhile, the graph of FIG. 8 illustrates, in comparison with the comparative example, how the curing promotion was influenced by the difference between the width of each elongated adhesive portion of the adhesive region of the third example, which is constituted of a plurality of elongated adhesive portions, and the width of each elongated adhesive portion of the adhesive region of the fourth example, which is also constituted of a plurality of elongated adhesive portions.

Referring to the graph of FIG. 8, the total surface area of the side faces in the adhesive region of the third example, which is constituted of the narrower width adhesive portions, is as large as about twice the total surface area of the side faces in the adhesive region of the fourth example, and thus the curing promotion effect of the third example is better than that of the fourth example.

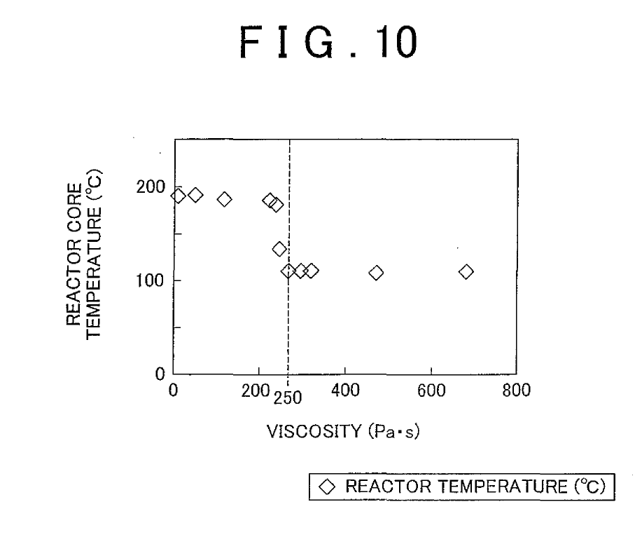

Meanwhile, the graph of FIG. 9 illustrates, in comparison with the comparative example, how the curing promotion was influenced by the differences between the form of the adhesive region of the second example, which is constituted of a plurality of round adhesive portions shaped like “spots”, the form of the adhesive region of the fourth example, which is constituted of a plurality of elongated adhesive portions, and the form of the adhesive region of the fifth example, which is constituted of an elongated adhesive portion that meanders.

Referring to the graph of FIG. 9, it has been proved that the levels of the curing promotion effects of the second, fourth, and fifth examples are equally high as compared to the comparative example.

Thus, with regard to the above-described example adhesive region forms for the reactor of the invention, it has been proved that all the forms of the first to fifth examples largely shorten the time required for the curing of the moisture-curable adhesive, as compared to the comparative example.

Further, the inventors prepared reactors using multiple moisture-curable adhesives with different viscosities, and conducted a test for measuring the temperatures of the respective reactor cores while driving them.

The test was conducted to identify, through the measurement of the temperatures of the respective reactor cores, the adhesive viscosities that prevent or minimize running of the applied adhesive, in view of the fact that whether the adhesive in the adhesive region runs depends on the viscosity of the adhesive used, and the fact that, if the adhesive runs, the contact area between the reactor core (and the coil) of the reactor and the adhesive in the adhesive region decreases, reducing the heat transfer via the adhesive region and thus resulting in an increase in the operation temperature of the reactor core. FIG. 10 illustrates the result of this test.

Referring to FIG. 10, the operation temperature of each reactor core having an adhesive region formed of an adhesive of which the viscosity is lower than 250 Pa·s, which is the boundary, increased to as high as approximately 200° C., while the temperature, to which the operation temperature of each reactor core having an adhesive region formed of an adhesive of which the viscosity is 250 Pa·s or higher increases, is a relatively low temperature of approximately 110° C.

Therefore, it is possible to conclude that, in order to ensure a high heat dissipation performance of the reactor, the viscosity of the adhesive used for forming an adhesive region is preferably at least 250 Pa·s.

Meanwhile, the adhesive viscosity may be set within the range of about 250 to 300 Pa·s in view of the fact that as long as the adhesive viscosity is equal to or higher than 250 Pa·s, the operation temperature of the reactor core is substantially unchanged even if the adhesive viscosity is further increased, and the fact that the higher the adhesive viscosity, the lower the efficiency in applying the adhesive.

While embodiments of the invention have been described in detail with reference to the drawings, specific configurations of the invention are not limited to these embodiments. Those with design modifications without departing from the scope of the invention are included in the scope of the invention.

1.-15. (canceled)

16. A reactor comprising:
a reactor core that is generally annular and that has a coil; and
a continuous surface of one of a housing and a cooler to which a continuous surface of at least one of the reactor core and the coil is fixed via an adhesive region that is formed of a moisture-curable adhesive, characterized in that:
the adhesive region between the two continuous surfaces is discontinuous in at least one planar direction of the adhesive region,
the adhesive region includes at least five gaps that are free of the moisture-curable adhesive and that are arranged in the at least one planar direction of the adhesive region.

17. The reactor according to claim 16 wherein the adhesive region is constituted of a plurality of adhesive portions that are discontinuously arranged.

18. The reactor according to claim 17, wherein planar shapes of the adhesive portions are round, elliptic, or polygonal.

19. The reactor according to claim 16, wherein the moisture-curable adhesive is a silicone-based moisture-curable adhesive or an acryl-based moisture-curable adhesive.

20. The reactor according to claim 16, wherein the moisture-curable adhesive contains a heat-conductive filler containing at least one of silica, alumina, aluminum nitride, and boron nitride.

21. The reactor according to claim 17, wherein the adhesive portions are spaced at least 0.5 mm apart from each other.

22. The reactor according to claim 16, wherein the adhesive region is constituted of an elongated adhesive portion that is formed of the moisture-curable adhesive and that extends continuously or a plurality of elongated adhesive portions that are each formed of the moisture-curable adhesive and that are discontinuously arranged.

23. The reactor according to claim 22, wherein the continuously extending elongated adhesive portion is a single elongated adhesive portion that meanders or a single elongated adhesive portion that is spiral.

24. The reactor according to claim 22, wherein the discontinuously arranged elongated adhesive portions are straight elongated adhesive portions that are substantially in parallel to each other and are spaced apart from each other or circular elongated adhesive portions that are different in diameter from each other and are spaced apart from each other.

25. The reactor according to claim 22, wherein the continuously extending elongated adhesive portion or the discontinuously arranged elongated adhesive portions is or are formed by applying the moisture-curable adhesive onto one of a bottom plate of the housing and the cooler while moving an application nozzle continuously.

26. The reactor according to claims 22, wherein the discontinuously arranged elongated adhesive portions are spaced at least 0.5 mm apart from each other.

27. The reactor according to claim 16, wherein a viscosity of the moisture-curable adhesive is equal to or higher than 250 Pa·s.

28. The reactor according to claim 27, wherein the viscosity of the moisture-curable adhesive is within a range of 250 to 300 Pa·s.

29. A method for producing the reactor according to claim 16, wherein the adhesive portions are formed by applying the moisture-curable adhesive onto one of a bottom plate of the housing and the cooler using a mask that has a plurality of openings.
